(19) United States
(12) Patent Application Publication
(10) Pub. No.: US 2026/0016719 A1
(43) Pub. Date: Jan. 15, 2026

(54) DISPLAY PANEL

(71) Applicant: HannStar Display Corporation, Taipei City (TW)

(72) Inventors: Ying-Jung Chen, Taipei City (TW); Cheng-Yen Yeh, Taipei City (TW); Ling Chih Kao, Taipei City (TW); Shao-Chien Chang, Taipei City (TW); Jing-Ya Chiu, Taipei City (TW); Qi-En Luo, Taipei City (TW)

(73) Assignee: HannStar Display Corporation, Taipei City (TW)

(21) Appl. No.: 19/015,574

(22) Filed: Jan. 9, 2025

(30) Foreign Application Priority Data
Jul. 12, 2024 (TW) 113126113

(51) Int. Cl. G02F 1/1335; G02F 1/1339

(52) U.S. Cl. CPC G02F 1/133553; G02F 1/13394

(57) ABSTRACT

A display panel including a first substrate, a second substrate, a liquid crystal layer, a pixel structure and a plurality of spacers is provided. The first substrate and the second substrate are disposed opposite to each other. The liquid crystal layer is disposed between the first substrate and the second substrate. The pixel structure is disposed on the first substrate and has a reflective layer. The reflective layer is divided into a plurality of reflective patterns by a plurality of slits, and the reflective patterns are connected to each other. The spacers are disposed between the first substrate and the second substrate. An orthographic projection of the spacers on the first substrate is located within an orthographic projection of the reflective patterns on the first substrate. The slits and the spacers are alternately arranged along at least one direction.

### CROSS-REFERENCE TO RELATED APPLICATION

This application claims the priority benefit of Taiwan application serial no. 113126113, filed on Jul. 12, 2024. The entirety of the above-mentioned patent application is hereby incorporated by reference herein and made a part of this specification.

### BACKGROUND

### Technical Field

The disclosure relates to a display technology, and more particularly, to a display panel.

### Description of Related Art

Total Reflective display panels primarily use natural or ambient light as a light source for display. Therefore, they are commonly used outdoor or in well-lit environments, such as outdoor billboards, electronic tags, sports watches, etc. However, due to the limitations of the liquid crystal materials themselves, total reflective display panels generally have a narrower range of viewing angle and suffer from a serious color shift issue of display at large viewing angles.

### SUMMARY

The disclosure provides a display panel with a larger range of viewing angle and better color performance at large viewing angles.

A display panel in the disclosure includes a first substrate, a second substrate, a liquid crystal layer, a pixel structure and a plurality of spacers. The first substrate and the second substrate are disposed opposite to each other. The liquid crystal layer is disposed between the first substrate and the second substrate. The pixel structure is disposed on the first substrate and has a reflective layer. The reflective layer is divided into a plurality of reflective patterns by a plurality of slits, and the reflective patterns are connected to each other. The spacers are disposed between the first substrate and the second substrate. An orthographic projection of the spacers on the first substrate is located within an orthographic projection of the reflective patterns on the first substrate. The slits and the spacers are alternately arranged along at least one direction.

In an embodiment of the disclosure, the reflective layer of the display panel has a first side edge and a second side edge arranged along a first direction and parallel to each other. The slits include a plurality of first slits and a plurality of second slits. The first slits extend from the first side edge and are spaced apart along a second direction. The first direction intersects the second direction. The second slits extend from the second side edge and are spaced apart along the second direction. A spacing is provided between the first slits and the second slits along the first direction.

In an embodiment of the disclosure, the spacers of the display panel include a plurality of first spacers and a plurality of second spacers, the first spacers and the first slits are alternately arranged along the second direction. The second spacers and the second slits are alternately arranged along the second direction. A plurality of third slits of the slits are provided between the first spacers and the second spacers. An extension direction of each of the third slits intersects an extension direction of each of the first slits and an extension direction of each of the second slits.

In an embodiment of the disclosure, the third slits of the display panel are aligned with each other along the second direction and spaced apart from each other. One of the third slits is provided between one of the first spacers and one of the second spacers adjacently arranged along the first direction.

In an embodiment of the disclosure, the reflective layer of the display panel further has a third side edge and a fourth side edge arranged along the second direction and facing away from each other. One of the third slits extends from the third side edge. Another one of the third slits extends from the fourth side edge. Part of the third slits is spaced apart from the first side edge, the second side edge, the third side edge and the fourth side edge.

In an embodiment of the disclosure, an orthographic projection profile of each of the spacers of the display panel on the first substrate is circular.

In an embodiment of the disclosure, the first spacers of the display panel include a plurality of first sub-spacers and a plurality of second sub-spacers. An orthographic projection profile of each of the first sub-spacers on the first substrate has a first shape. An orthographic projection profile of each of the second sub-spacers on the first substrate has a second shape. The first shape is different from the second shape.

In an embodiment of the disclosure, an extension direction of each of the second sub-spacers of the display panel intersects the first direction and the second direction. An extension direction of one of the second sub-spacers intersects an extension direction of another one of the second sub-spacers.

In an embodiment of the disclosure, the number of the second sub-spacers of the display panel is different from the number of the first sub-spacers.

In an embodiment of the disclosure, the second spacers of the display panel include a plurality of third sub-spacers and a plurality of fourth sub-spacers. An orthographic projection profile of each of the third sub-spacers on the first substrate has the first shape. An orthographic projection profile of each of the fourth sub-spacers on the first substrate has the second shape. The first sub-spacers are misaligned with the third sub-spacers along the first direction. The second sub-spacers are misaligned with the fourth sub-spacers along the first direction.

Based on the above, in a display panel according to an embodiment of the disclosure, a reflective layer of a pixel structure is divided into a plurality of reflective patterns connected to each other through a plurality of slits. The reflective patterns are overlapped with a plurality of spacers. The spacers and the slits are alternately arranged along at least one direction, and thereby diversifying the alignment directions of a plurality of liquid crystal molecules in the liquid crystal layer. Accordingly, the viewing angle range of the display panel may be increased, and the color shift issue of display at large viewing angles may be effectively improved.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic cross-sectional view of a display panel according to a first embodiment of the disclosure.

FIG. 2 is an enlarged schematic view of a partial area of the display panel of FIG. 1.

FIG. 3 is a schematic top view of a reflective layer and a plurality of spacers in FIG. 1.

FIG. 4 is a schematic top view of a reflective layer and a plurality of spacers according to a second embodiment of the disclosure.

FIG. 5 is a schematic top view of a reflective layer and a plurality of spacers according to a third embodiment of the disclosure.

FIG. 6 is a schematic top view of a reflective layer and a plurality of spacers according to a fourth embodiment of the disclosure.

### DESCRIPTION OF THE EMBODIMENTS

Exemplary embodiments of the disclosure are now described in detail with reference to the accompanying drawings. Wherever possible, the same reference numerals are used in the drawings and the description to refer to the same or similar parts.

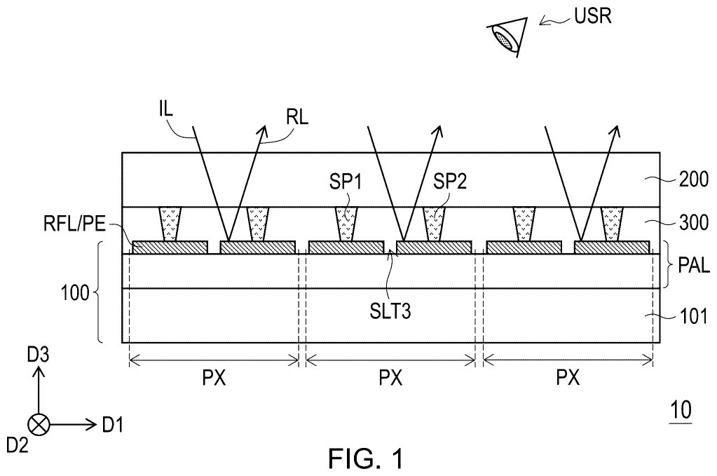

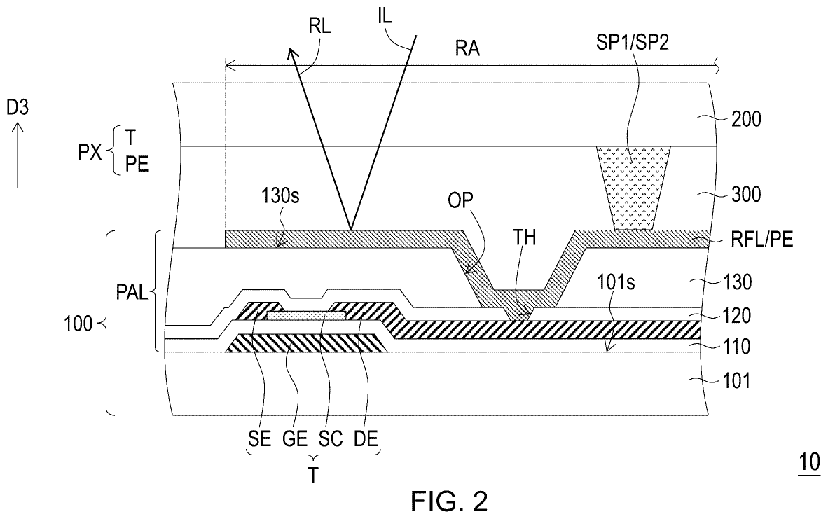

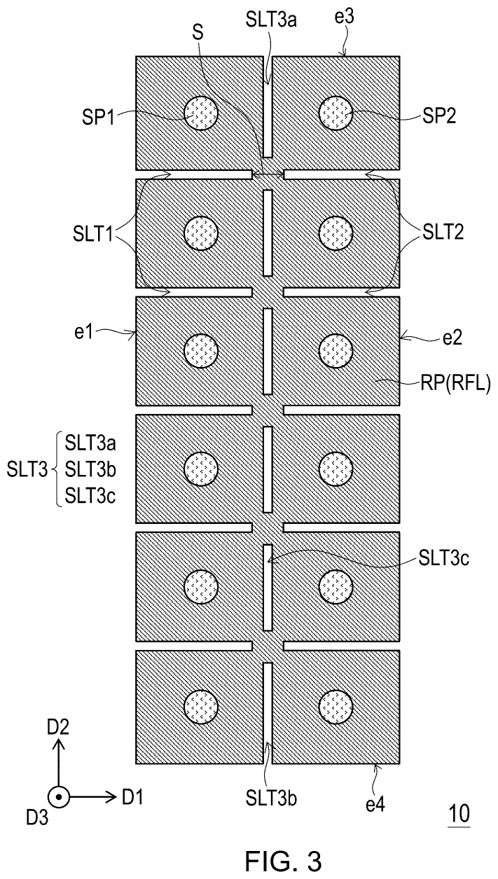

FIG. 1 is a schematic cross-sectional view of a display panel according to a first embodiment of the disclosure. FIG. 2 is an enlarged schematic view of a partial area of the display panel of FIG. 1. FIG. 3 is a schematic top view of a reflective layer and a plurality of spacers in FIG. 1.

Referring to FIG. 1, a display panel 10 includes a pixel array substrate 100. In the embodiment, the pixel array substrate 100 may include a first substrate 101 and a plurality of pixel structures PX. Although FIG. 1 only shows a plurality of pixel structures PX of the pixel array substrate 100 arranged along a first direction D1, it can be understood that the plurality of pixel structures PX may be arranged in an array on the first substrate 101. For example, the pixel structures PX may be arranged in multiple rows and multiple columns along two directions (e.g., the first direction D1 and a second direction D2) perpendicular to each other. The material of the first substrate 101 may include glass, quartz, high molecular polymer (e.g., polyimide, polycarbonate, polymethyl methacrylate, or other suitable flexible materials), or other suitable materials for substrate.

Referring to FIG. 1 and FIG. 2, from another perspective, the plurality of pixel structures PX may constitute a pixel array layer PAL of the display panel 10. The pixel structure PX includes a reflective layer RFL and an active device T. In the embodiment, the reflective layer RFL may be electrically connected to the active device T. That is, the reflective layer RFL may simultaneously serve as a pixel electrode PE of the pixel structure PX, but the disclosure is not limited thereto. In other embodiments, the pixel electrode PE and the reflective layer RFL may be provided separately and stacked on each other.

In the embodiment, an incident light IL, after being reflected by the reflective layer RFL, forms a reflected light RL to create a corresponding display image in eyes of a user USR. In the embodiment, the incident light IL may be ambient light, light from a front light module, or a combination of the foregoing.

In the embodiment, a method of forming the active device T may include the following steps: sequentially forming a gate electrode GE, a gate insulating layer 110, a semiconductor pattern SC, a source electrode SE and a drain electrode DE on the first substrate 101. The semiconductor pattern SC overlaps the gate electrode GE. The source electrode SE and the drain electrode DE overlap the semiconductor pattern SC and are in electrical contact with two different regions of the semiconductor pattern SC. In the embodiment, the gate electrode GE of the active device T may be selectively disposed below the semiconductor pattern SC to form a bottom-gate thin film transistor (bottom-gate TFT), but the disclosure is not limited thereto. In other embodiments, the gate electrode of the active device may be selectively disposed above the semiconductor pattern to form a top-gate thin film transistor (top-gate TFT).

It should be noted that the gate electrode GE, the source electrode SE, the drain electrode DE, the semiconductor pattern SC and the gate insulating layer 110 may be realized by any gate electrode, any source electrode, any drain electrode, any semiconductor pattern and any gate insulating layer for a display panel that is well known to those skilled in the art, and the gate electrode GE, the source electrode SE, the drain electrode DE, the semiconductor pattern SC and the gate insulating layer 110 may be formed by any method well known to those skilled in the art. Therefore, detail descriptions are omitted here.

Furthermore, the pixel array substrate 100 may further include a passivation layer 120 and a planarization layer 130, but the disclosure is not limited thereto. In some embodiments, the pixel array substrate 100 may only be provided with the passivation layer 120 or the planarization layer 130. In the embodiment, the passivation layer 120 covers a plurality of active devices T of the plurality of pixel structures PX. The planarization layer 130 covers the passivation layer 120. In the embodiment, the material of the planarization layer 130 may be an organic material, and the material of the passivation layer 120 may be an inorganic material. The passivation layer 120 is located between the planarization layer 130 and a metal layer (e.g., the source electrode SE and the drain electrode DE of the active device T) to prevent the planarization layer 130 and the metal layer from peeling off due to poor adhesion, but the disclosure is not limited thereto.

In the embodiment, the pixel electrode PE (i.e., the reflective layer RFL) of the pixel structure PX is disposed on a surface 130s of the planarization layer 130 facing away from the first substrate 101, and is electrically connected to the drain electrode DE of the active device T through an opening OP of the planarization layer 130 and a through hole TH of the passivation layer 120.

For example, the display panel 10 may further include a second substrate 200 and a liquid crystal layer 300. The liquid crystal layer 300 is disposed between the first substrate 101 of the pixel array substrate 100 and the second substrate 200. A color filter layer (not shown) and/or a common electrode layer (not shown) may be provided on the second substrate 200. The electric field generated between the common electrode layer and the pixel electrode PE is suitable to drive a plurality of liquid crystal molecules (not shown) of the liquid crystal layer 300 to rotate to form an alignment state corresponding to the direction and intensity of the electric field. By changing the alignment state of the liquid crystal molecules, the polarization states of the incident light IL and the reflected light RL passing through the liquid crystal layer 300 are changed to produce a brightness of light output corresponding to the alignment state. In some embodiments, the common electrode layer may also be disposed in the pixel array substrate 100.

On the other hand, the pixel array substrate 100 and the second substrate 200 may also be provided with two alignment layers (not shown) on two opposite surfaces thereof, respectively, and the two alignment layers are used to align the plurality of liquid crystal molecules of the liquid crystal layer 300.

It should be noted that the display panel 10 of the embodiment may be a total reflective display panel having only a reflective area RA, and the reflective area RA is defined by the reflective layer RFL, but the disclosure is not limited thereto. In other embodiments not shown, the display panel may also be a transflective display panel having a reflective area and a transmissive area.

Referring to FIG. 1 to FIG. 3, in the embodiment, the reflective layer RFL is provided with a plurality of slits, and the slits can divide the reflective layer RFL into a plurality of reflective patterns RP. It is particularly noted that although the reflective patterns RP are segmented by the plurality of slits, they still remain interconnected to maintain the functionality of the reflective layer RFL as the pixel electrode PE.

In the embodiment, the slits may include a plurality of first slits SLT1, a plurality of second slits SLT2 and a plurality of third slits SLT3. For example, the plurality of first slits SLT1 may extend from a first side edge e1 of the reflective layer RFL in the first direction D1 and be spaced apart along the second direction D2. The plurality of second slits SLT2 may extend from the second side edge e2 of the reflective layer RFL in the first direction D1 and be spaced apart along the second direction D2. The first slits SLT1 are respectively aligned with the second slits SLT2 along the first direction D1, and a spacing S is provided between the first slits SLT1 and the second slits SLT2.

On the other hand, the plurality of third slits SLT3 are aligned with each other along the second direction D2 and spaced apart between a third side edge e3 and a fourth side edge e4 of the reflective layer RFL. An extension direction of the third slit SLT3 intersects an extension direction of the first slit SLT1 and an extension direction of the second slit SLT2. It is particularly noted that the third slits SLT3 include one extending from the third side edge e3 (e.g., the third slit SLT3a), another one extending from the fourth side edge e4 (e.g., the third slit SLT3b), and a portion (e.g., the third slits SLT3c) spaced apart from the first side edge e1, the second side edge e2, the third side edge e3 and the fourth side edge e4.

In the embodiment, the first side edge e1 and the second side edge e2 of the reflective layer RFL are arranged along the first direction D1 and are substantially parallel to each other, and the third side edge e3 and the fourth side edge e4 are, for example, arranged along the second direction D2 and substantially parallel to each other. Specifically, the relative relationship where an included angle between an extension direction of the first side edge e1 and an extension direction of the second side edge e2 is within 3 degrees, or where an included angle between an extension direction of the third side edge e3 and an extending direction of the fourth side edge e4 is within 3 degrees, still falls under the aforementioned parallelism.

Furthermore, the display panel 10 further includes a plurality of spacers disposed between the first substrate 101 and the second substrate 200, such as a plurality of first spacers SP1 and a plurality of second spacers SP2. In the embodiment, the spacers may be selectively disposed on the second substrate 200, but the disclosure is not limited thereto. In other embodiments, the spacers may also be disposed on the pixel array substrate 100.

It is particularly noted that an orthographic projection of the spacers on the first substrate 101 is located within an orthographic projection of the plurality of reflective patterns RP of the reflective layer RFL on the first substrate 101. That is, the spacers completely overlap the reflective patterns RP along a normal direction (e.g., a third direction D3) of a substrate surface 101s of the first substrate 101 (as shown in FIG. 3). The spacers and the plurality of slits of the reflective layer RFL are alternately arranged along at least one direction.

For example, the plurality of first spacers SP1 and the plurality of first slits SLT1 may be alternately arranged along the second direction D2. The plurality of second spacers SP2 and the plurality of second gaps SLT2 may be alternately arranged along the second direction D2. The plurality of third slits SLT3 are provided between the plurality of first spacers SP1 and the plurality of second spacers SP2. More specifically, a third slits SLT3 is provided between a first spacer SP1 and a second spacer SP2 adjacently arranged along the first direction D1. From another point of view, each reflective pattern RP of the reflective layer RFL is provided with a spacer.

By arranging the aforementioned slits on the reflective layer RFL and providing the spacers overlapping the plurality of reflective patterns RP divided by the slits, the alignment directions of the plurality of liquid crystal molecules (not shown) in the liquid crystal layer 300 can be diversified. Accordingly, the viewing angle range of the display panel 10 may be increased, and the color shift issue of display of the display panel 10 at large viewing angles may be effectively improved.

Furthermore, in the embodiment, an orthographic projection profile of each spacer, such as the first spacer SP1 and the second spacer SP2, on the first substrate 101 is, for example, circular, but the disclosure is not limited thereto.

Other embodiments will be enumerated below to describe the present disclosure in detail, in which the same components will be denoted by the same symbols, and descriptions of the same technical content will be omitted. Please refer to the previous embodiments for the omitted parts, which will not be described again below.

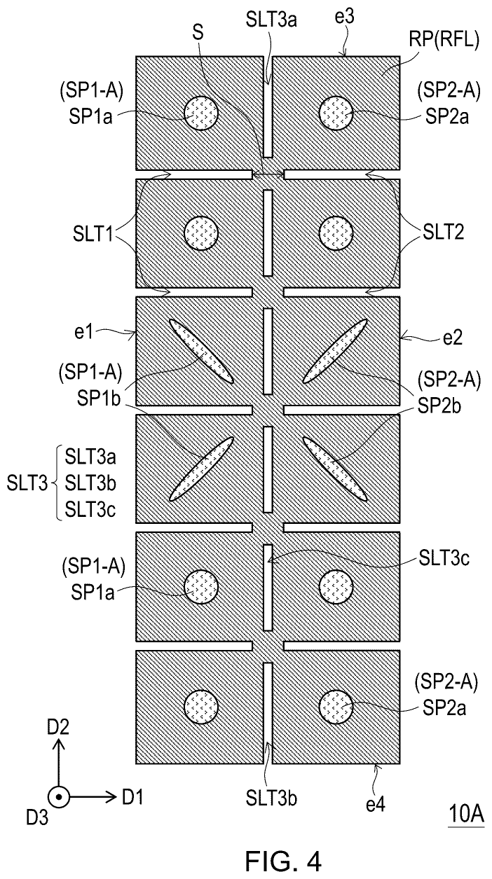

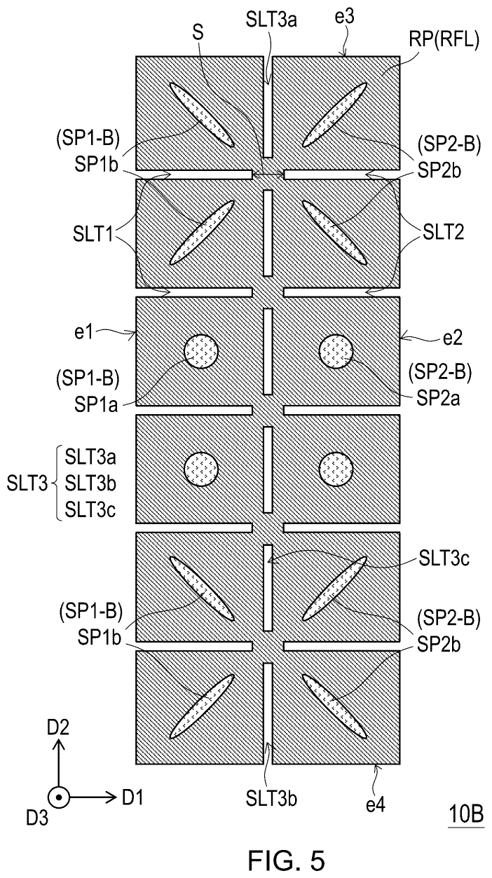

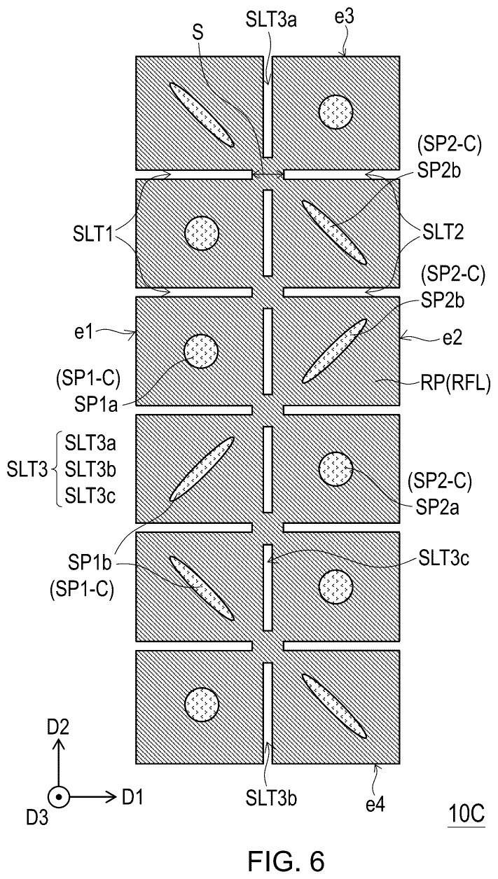

FIG. 4 is a schematic top view of a reflective layer and a plurality of spacers according to a second embodiment of the disclosure. FIG. 5 is a schematic top view of a reflective layer and a plurality of spacers according to a third embodiment of the disclosure. FIG. 6 is a schematic top view of a reflective layer and a plurality of spacers according to a fourth embodiment of the disclosure.

Referring to FIG. 4, the difference between a display panel 10A of the embodiment and the display panel 10 of FIG. 3 lies in that the configuration of part of the spacers is different. For example, in the display panel 10A of the embodiment, the plurality of first spacers SP1-A may be divided into a plurality of first sub-spacers SP1a and a plurality of second sub-spacers SP1b. An orthographic projection profile of each of the first sub-spacers SP1a on the first substrate 101 has a first shape. An orthographic projection profile of each of the second sub-spacers SP2a on the first substrate 101 has a second shape, and the first shape is different from the second shape.

In the embodiment, the first shape is, for example, a circle, and the second shape is, for example, a spindle shape, but the disclosure is not limited thereto. In other embodiments, the second shape may be an elongated shape or an elliptical shape. It is particularly noted that an extension direction of each of the second sub-spacers SP1b intersects the first direction D1 and the second direction D2, and an extension direction of a part of the second sub-spacers SP1b intersects an extension direction of another part of the second sub-spacers SP1b.

Similarly, the plurality of second spacers SP2-A may be divided into a plurality of third sub-spacers SP2a and a plurality of fourth sub-spacers SP2b. An orthographic projection profile of each of the third sub-spacers SP2a on the first substrate 101 has the first shape, and an orthographic projection profile of each of the fourth sub-spacers SP2b on the first substrate 101 has the second shape. An extension direction of each of the fourth sub-spacers SP2b intersects the first direction D1 and the second direction D2, and an extension direction of a part of the fourth sub-spacers SP2b intersects an extension direction of another part of the fourth sub-spacers SP2b.

In particular, the plurality of second sub-spacers SP1b and the plurality of fourth sub-spacers SP2b each have a specific extension direction, which helps to enhance the alignments of the liquid crystal molecules in specific directions, thereby increasing the visibility of the display panel 10A at specific viewing angles.

On the other hand, the number of the plurality of second sub-spacers SP1b may be different from the number of the plurality of first sub-spacers SP1a, and the number of the plurality of fourth sub-spacers SP2b may be different from the number of the plurality of third sub-spacers SP2a. In the embodiment, the number of the second sub-spacers SP1b may be less than the number of the first sub-spacers SP1a, and the number of the fourth sub-spacers SP2b may be less than the number of the third sub-spacers SP2a, but the disclosure is not limited thereto.

Referring to FIG. 5, in a display panel 10B of an embodiment, the number of the first sub-spacers SP1a of the plurality of first spacers SP1-B may be less than the number of the second sub-spacers SP1b, and the number of the third sub-spacers SP2a of the plurality of second spacers SP2-B may be less than the number of the fourth sub-spacers SP2b. Accordingly, compared with the display panel 10A in FIG. 4, the alignments of the liquid crystal molecules of the display panel 10B in specific directions may be further enhanced, and thereby increasing the visibility of the display panel 10B at specific viewing angles.

However, the disclosure is not limited thereto. Referring to FIG. 6, in a display panel 10C of an embodiment, the number of the first sub-spacers SP1a of the plurality of first spacers SP1-C may be equal to the number of the second sub-spacers SP1b, and the number of the third sub-spacers SP2a of the plurality of second spacers SP2-C may be equal to the number of the fourth sub-spacers SP2b. Accordingly, the display panel 10C can achieve a balance of display effects at multiple viewing angles and specific viewing angles.

It is particularly noted that in the display panel 10A of FIG. 4 or the display panel 10B of the FIG. 5, the plurality of first sub-spacers SP1a are respectively aligned with the plurality of third sub-spacers SP2a along the first direction D1, and the plurality of second sub-spacers SP1b are respectively aligned with the plurality of fourth sub-spacers SP2b along the first direction D1. However, in the display panel 10C of FIG. 6, the plurality of first sub-spacers SP1a are misaligned with the plurality of third sub-spacers SP2a along the first direction D1, and the plurality of second sub-spacers SP1b are misaligned with the plurality of fourth sub-spacers SP2b along the first direction D1.

To sum up, in a display panel according to an embodiment of the disclosure, a reflective layer of a pixel structure is divided into a plurality of reflective patterns connected to each other through a plurality of slits. The reflective patterns are overlapped with a plurality of spacers. The spacers and the slits are alternately arranged along at least one direction, and thereby diversifying the alignment directions of a plurality of liquid crystal molecules in the liquid crystal layer. Accordingly, the viewing angle range of the display panel may be increased, and the color shift issue of display at large viewing angles may be effectively improved.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A display panel, comprising:
a first substrate and a second substrate, disposed opposite to each other;
a liquid crystal layer, disposed between the first substrate and the second substrate;
a pixel structure, disposed on the first substrate and having a reflective layer, wherein the reflective layer is divided into a plurality of reflective patterns by a plurality of slits, and the reflective patterns are connected to each other; and
a plurality of spacers, disposed between the first substrate and the second substrate, wherein an orthographic projection of the spacers on the first substrate is located within an orthographic projection of the reflective patterns on the first substrate, and the slits and the spacers are alternately arranged along at least one direction.

2. The display panel according to claim 1, wherein the reflective layer has a first side edge and a second side edge arranged along a first direction and parallel to each other, and the slits include:
a plurality of first slits, extending from the first side edge and spaced apart along a second direction, wherein the first direction intersects the second direction; and
a plurality of second slits, extending from the second side edge and spaced apart along the second direction, wherein a spacing is provided between the first slits and the second slits along the first direction.

3. The display panel according to claim 2, wherein the spacers include a plurality of first spacers and a plurality of second spacers, the first spacers and the first slits are alternately arranged along the second direction, the second spacers and the second slits are alternately arranged along the second direction, a plurality of third slits of the slits are provided between the first spacers and the second spacers, and an extension direction of each of the third slits intersects an extension direction of each of the first slits and an extension direction of each of the second slits.

4. The display panel according to claim 3, wherein the third slits are aligned with each other along the second direction and spaced apart from each other, and one of the third slits is provided between one of the first spacers and one of the second spacers adjacently arranged along the first direction.

5. The display panel according to claim 4, wherein the reflective layer further has a third side edge and a fourth side edge arranged along the second direction and facing away from each other, one of the third slits extends from the third side edge, another one of the third slits extends from the fourth side edge, and part of the third slits is spaced apart from the first side edge, the second side edge, the third side edge and the fourth side edge.

6. The display panel according to claim 5, wherein an orthographic projection profile of each of the spacers on the first substrate is circular.

7. The display panel according to claim 5, wherein the first spacers include a plurality of first sub-spacers and a plurality of second sub-spacers, an orthographic projection profile of each of the first sub-spacers on the first substrate has a first shape, an orthographic projection profile of each of the second sub-spacers on the first substrate has a second shape, and the first shape is different from the second shape.

8. The display panel according to claim 7, wherein an extension direction of each of the second sub-spacers intersects the first direction and the second direction, and an extension direction of one of the second sub-spacers intersects an extension direction of another one of the second sub-spacers.

9. The display panel according to claim 7, wherein the number of the second sub-spacers is different from the number of the first sub-spacers.

10. The display panel according to claim 7, wherein the second spacers include a plurality of third sub-spacers and a plurality of fourth sub-spacers, an orthographic projection profile of each of the third sub-spacers on the first substrate has the first shape, an orthographic projection profile of each of the fourth sub-spacers on the first substrate has the second shape, the first sub-spacers are misaligned with the third sub-spacers along the first direction, and the second sub-spacers are misaligned with the fourth sub-spacers along the first direction.
